(19) United States
(12) Patent Application Publication
(10) Pub. No.: US 2019/0020659 A1
(43) Pub. Date: Jan. 17, 2019

(54) ROLE-BASED ACCESS CONTROL WITH FEATURE-LEVEL GRANULARITY

(71) Applicant: NICIRA, INC., Palo Alto, CA (US)

(72) Inventors: ANANDA LONI, Pune (IN); VAIBHAV BHANDARI, Pune (IN)

(21) Appl. No.: 15/861,705

(22) Filed: Jan. 4, 2018

(30) Foreign Application Priority Data
Jul. 12, 2017 (IN) 201741024642

(51) Int. Cl. H04L 29/06; G06F 21/62

(52) U.S. Cl. CPC H04L 63/102; G06F 21/629; G06F 9/54; H04L 63/105; H04L 63/20

(57) ABSTRACT

Example methods are provided for a computer system to perform role-based access control with feature-level granularity in a network environment. The method may include detecting a request for a user operating the client device to access one or more features of a web application, identifying a role assigned to the user and identifying one or more feature-level permissions associated with the role. A first feature of the web application may associate the role with a first feature-level permission, and a second feature of the web application may associate the role with a different second feature-level permission. The method may also include controlling access to the one or more features based on the one or more feature-level permissions.

### RELATED APPLICATIONS

Benefit is claimed under 35 U.S.C. 119(a)-(d) to Foreign Application Serial No. 201741024642 filed in India entitled “ROLE-BASED ACCESS CONTROL WITH FEATURE-LEVEL GRANULARITY”, on Jul. 12, 2017, by NICIRA, INC., which is herein incorporated in its entirety by reference for all purposes.

### BACKGROUND

Unless otherwise indicated herein, the approaches described in this section are not admitted to be prior art by inclusion in this section.

In computer system security, authentication refers generally to the process of validating a user's identity based on the user's credentials (e.g., username and password). After authentication is performed, access control is used as an approach to restrict system access to authenticated users. Role-based access control is a particular approach where roles are created for various job functions within an organization. A user may be assigned with one or more roles, through which the user acquires permissions to perform certain system operations. Since users are not assigned permissions directly, but only acquire them through their role or roles, management of individual rights becomes a matter of appropriate role assignment. However, in practice, conventional implementation of role-based access control may lack flexibility.

### BRIEF DESCRIPTION OF DRAWINGS

FIG. 1 is a schematic diagram illustrating an example network environment in which a role-based access control with feature-level granularity may be performed;

FIG. 2 is a flowchart of an example process for a computer system to perform role-based access control with feature-level granularity in a network environment;

FIG. 3 is a flowchart of an example detailed process for performing role-based access control with feature-level granularity in a network environment;

FIG. 4 is a schematic diagram illustrating an example configuration of feature-level permissions according to the example in FIG. 3;

FIG. 5A is a schematic diagram illustrating example configuration information associated with feature-level permissions;

FIG. 5B is a schematic diagram illustrating example configuration information associated with required permissions;

FIG. 6 is a flowchart of an example detailed process for performing role-based access control with feature-level granularity using a permission object; and

FIG. 7 is a schematic diagram illustrating an example computer system to perform role-based access control with feature-level granularity in a network environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

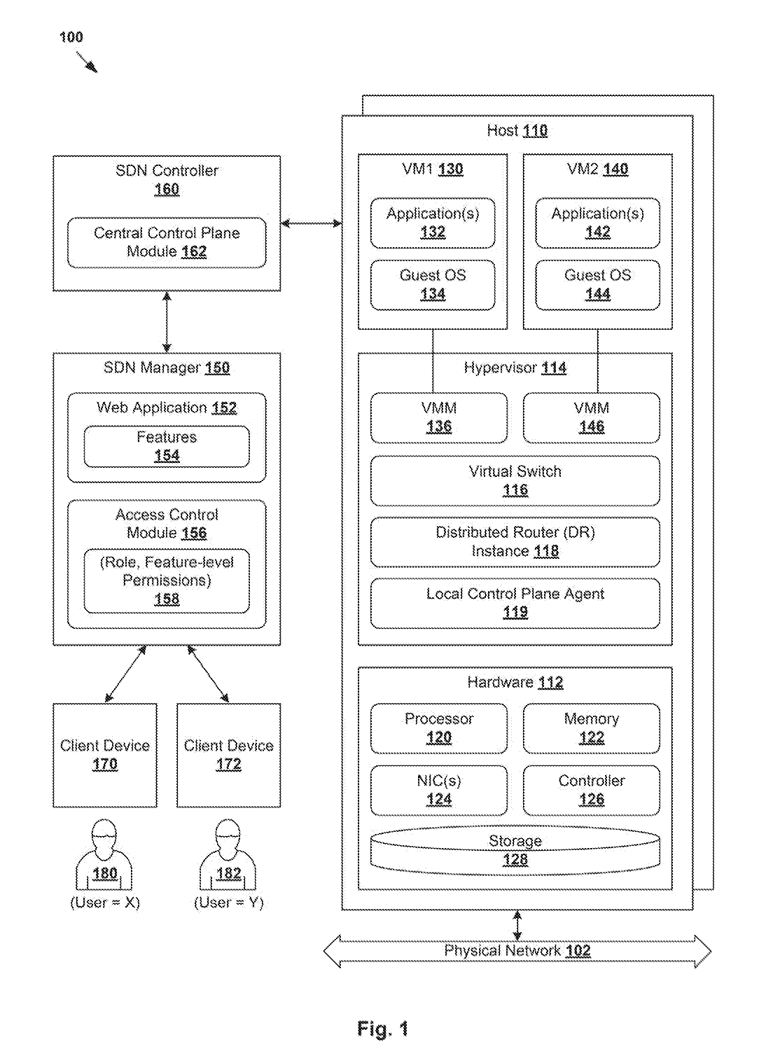

Challenges relating to access control will now be explained in more detail using FIG. 1, which is a schematic diagram illustrating example network environment 100 in which role-based access control with feature-level granularity may be performed.

It should be understood that, depending on the desired implementation, network environment 100 may include additional and/or alternative components than that shown in FIG. 1. Although described using a virtualized computing environment, it should be understood that examples of the present disclosure may be implemented in any suitable network environment that includes a computer system and a client device.

In the example in FIG. 1, network environment 100 is in the form of a virtualized computing environment that includes multiple hosts 110 (also known as “computing devices”, “host corn puters”, “host devices”, “physical servers”, “server systems”, etc.) connected via physical network 102. Each host 110 includes hardware 112 and virtualization software (e.g., hypervisor 114) to support multiple guest virtual machines, such as VM1 130 and VM2 140. Throughout the present disclosure, the term “hypervisor” may refer to any suitable corn puter hardware virtualization software that enables multiple virtual machines to execute simultaneously on a single host, such as VMware ESX® (available from VMware, Inc.). In practice, each host 110 may support tens or hundreds of virtual machines (two shown for simplicity in FIG. 1). The term “hypervisor” also includes system-level software that supports namespace containers such as Docker, etc.

Hypervisor 114 maintains a mapping between underlying hardware 112 and virtual resources allocated to virtual machines 130, 140. For example, hardware 112 includes processor(s) 120, physical memory 122 (e.g., random access memory (RAM)), physical network interface controller(s) or NIC(s) 124 to provide access to physical network 102, and storage disk(s) 128 (e.g., solid state drive, hard disk drive) accessible via storage controller 126, etc. In practice, hypervisor 114 may also be a “type 2” or hosted hypervisor that runs on top of a conventional operating system (OS) on host 110. Hypervisor 114 also implements virtual switch 116 and logical distributed router (DR) instance 118 to handle egress packets from, and ingress packets to, virtual machine 130/140. Depending on the desired implementation, virtual switch 116 and DR instance 118 may be configured to implement logical switches (e.g., using a forwarding table) and/or logical routers (e.g., using a routing table) that each span multiple hosts 110.

VM1 130 and VM2 140 each represent a software implementation of a physical machine. Virtual resources are allocated to virtual machine 130/140 to support guest OS 134/144, and application(s) 132/142, etc. Corresponding to hardware 112, the virtual resources may include virtual CPU, virtual memory, virtual disk, virtual network interface controller (vNIC), etc. Hardware resources may be emulated using virtual machine monitor (VMM) 136/146 implemented by hypervisor 114. In practice, VMM 136/146 may be considered as part of virtual machine 130/140, or alternatively, separated from the virtual machine.

Although examples of the present disclosure refer to virtual machines, it should be understood that a “virtual machine” running on host 110A is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running within a VM or on top of a host OS without the need for a hypervisor or separate OS or implemented as an OS level virtualization), virtual private servers, client computers, etc. Such container technology is available from, among others, Docker, Inc. The virtual machines may also be complete computational environments, containing virtual equivalents of the hardware and software components of a physical computing system.

Through software-defined networking (SDN), benefits similar to server virtualization may be derived for networking services. SDN manager 150 and SDN controller 160 are example network management entities that facilitate implementation of various virtualization technologies (e.g., logical overlay networks, logical switches, logical routers, etc.) in network environment 100. One example of an SDN controller is the NSX controller component of VMware NSX® (available from VMware, Inc.) that operates on a central control plane. SDN controller 160 may be a member of a controller cluster (not shown) that is configurable using SDN manager 150 operating on a management plane. Network management entity 150/160 may be implemented using physical machine(s), virtual machine(s), or both. SDN controller 160 implements central control plane module 162 to interact with local control plane agent 119 on host 110 for collecting and disseminating control information, etc.

In the example in FIG. 1, management and configuration of hosts 110 and virtual machines 130-140 may be performed by user 180/182 operating client device 170/172 by interacting with web application 152 supported by SDN manager 150. In practice, the interaction may be performed through any suitable interface supported by web application 152, such as Application Programming Interface (API), user interface (UI), command line interface (CLI), etc. For example, once a logical router is configured on host 110 via web application 152, SDN manager 150 may send any relevant configuration information to host 110 via SDN controller 160. Host 110 may implement local control plane agent 119 to receive or send any suitable information from central control plane module 162 implemented by SDN controller 160.

SDN manager 150 also performs access control (e.g., using access control module 156) to restrict access to web application 152. Conventionally, role-based access control may be implemented to assign user 180/182 with a set of permissions through role assignment. For example, user 180 may be assigned with a role that grants user 180 with a read permission across all features 154 of web application 152. Another user 182 may be assigned a different role that grants a read-write permission to access each and every feature 154 of web application 152. In practice, however, this lacks flexibility because the read permission assigned to user 180 may be inadequate, and a higher permission is required for some of features 154.

Role-Based Access Control with Feature-Level Granularity

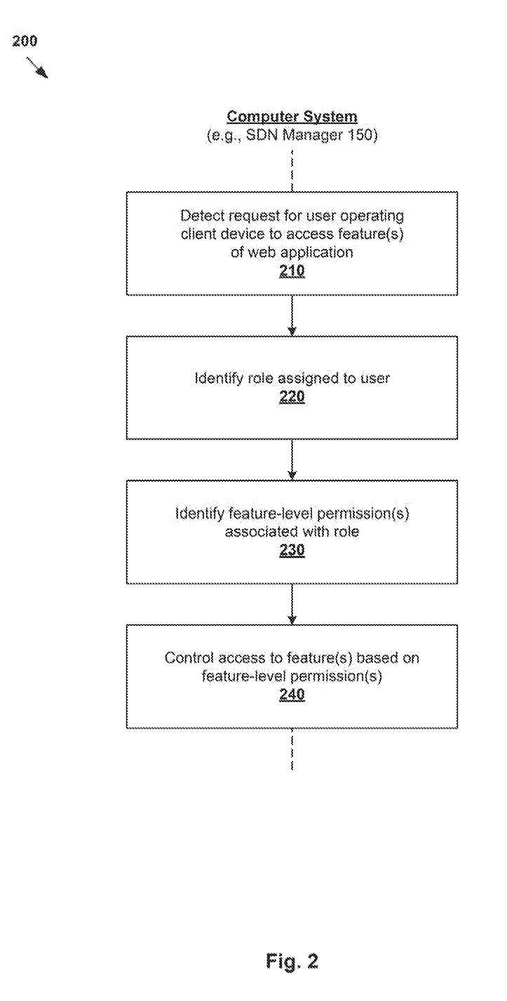

According to examples of the present disclosure, role-based access control may be implemented with feature-level granularity by associating a role with a set of feature-level permissions. In more detail, FIG. 2 is a flowchart of example process 200 for a computer system to perform role-based access control with feature-level granularity in network environment 100. Example process 200 may include one or more operations, functions, or actions illustrated by one or more blocks, such as 210 to 240. The various blocks may be combined into fewer blocks, divided into additional blocks, and/or eliminated depending on the desired implementation.

Throughout the present disclosure, various examples will be explained using SDN manager 150 as an example “computer system” and device 170/172 as an example “client device.” In this case, example process 200 may be implemented using SDN manager 150, such as using access control module 156, etc. Although FIG. 1 shows SDN manager 150 implementing web application 152, it should be understood that web application 152 may be implemented by any alternative or additional computer system(s) in network environment 100.

At 210 in FIG. 2, SDN manager 150 detects a request for user 180/182 operating client device 170/172 to access feature(s) of web application 152 (see 154 in FIG. 1). At 220 and 230, SDN manager 150 identifies a role assigned to user 180/182 and feature-level permission(s) associated with the role. At 240, SDN manager 150 controls access to feature(s) based on feature-level permission(s) associated with the role (see 158 in FIG. 1). For example in FIG. 1, user=Y (see 182) may be assigned with role=‘network operations,’ and web application 152 supports a set of features that includes first feature=‘networking’ and a second feature=‘troubleshooting.’

The features may associate the role with respective feature-level permissions. For example, the first feature may associate role=‘network operations’ with a first feature-level permission=‘read.’ In contrast, the second feature may associate the same role with a different second feature-level permission=‘execute.’ This way, instead of necessitating the role to have the same permission (e.g., read only) across different features, the same role may be assigned with different feature-level permissions for accessing different features. This provides greater control and flexibility over which roles (and therefore users) are allowed to access which features 154 of web application 152, and the level of access allowed.

As used herein, the term “role” may refer generally to a job function (or any suitable title) that describes the authority and responsibility conferred on a user assigned with the role within an organization, etc. The term “user” may refer to a human user or non-human user (e.g., bot) who interacts with a computer system through a client device. The term “feature” may refer generally to a collection of one or more functionalities, routines, operations, services, actions, processes, etc. In practice, a feature may be implemented using a set of APIs. Each API may define a set of rule(s) and specification(s) to perform an action or operation associated with a feature.

The term “feature-level permission” may refer generally to a particular mode of access to, or type of interaction a user may have with, a particular feature 154 of web application 152. In practice, any suitable permission may be configured, such as create, read, update and delete (CRUD), execute (E), read (R), none (N), etc. For example, ‘CRUD’ grants full access, while ‘NI’ grants no access. Depending on the desired implementation, permissions may be defined based on a “permission hierarchy” that orders the permissions according to priority or access level, such as CRUD>E>R>N. This way, assigning a higher level of permission (e.g., ‘E’) automatically assigns a lower level of permission (e.g., ‘R’), i.e., without having to assign the permissions separately. In practice, write (W) permission may be included in the hierarchy, such as before execute.

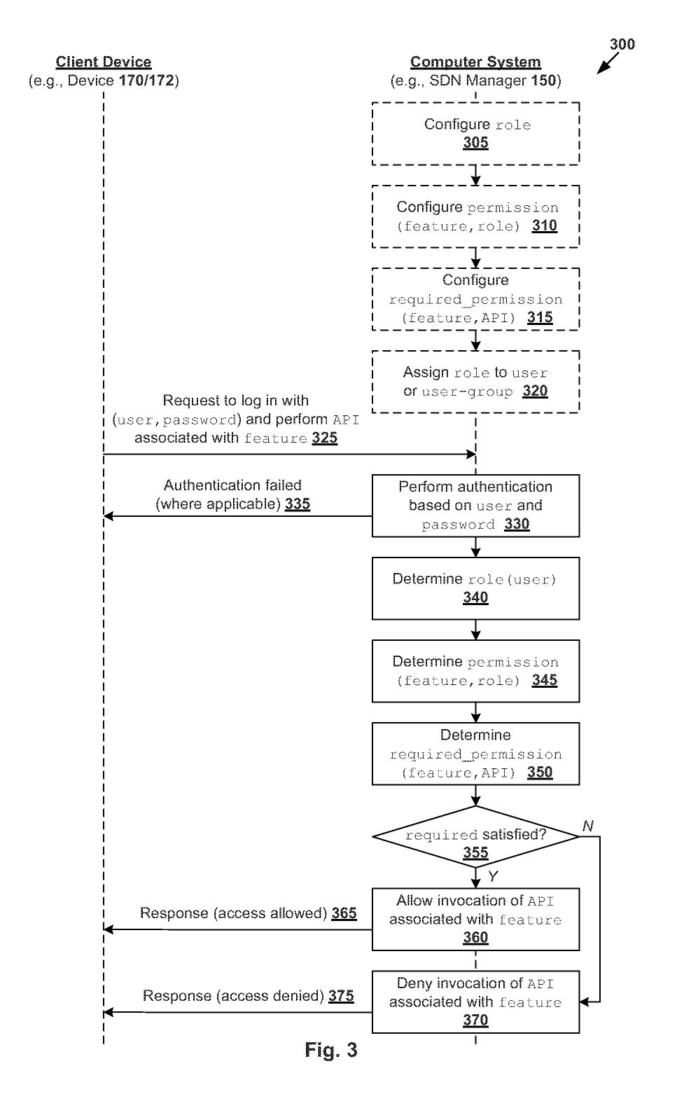

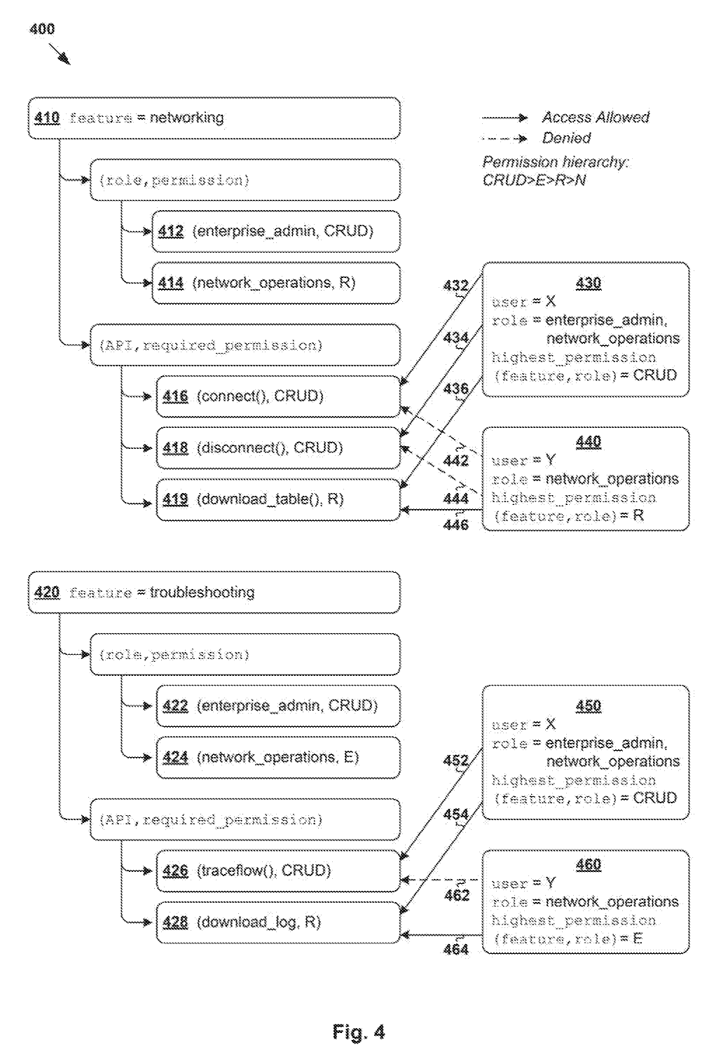

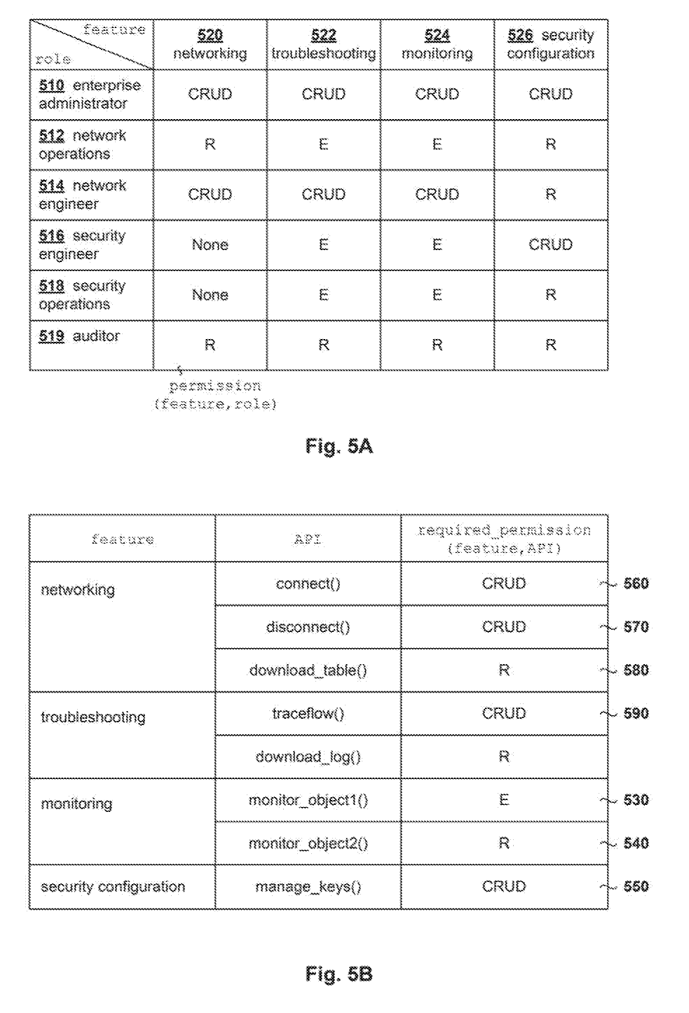

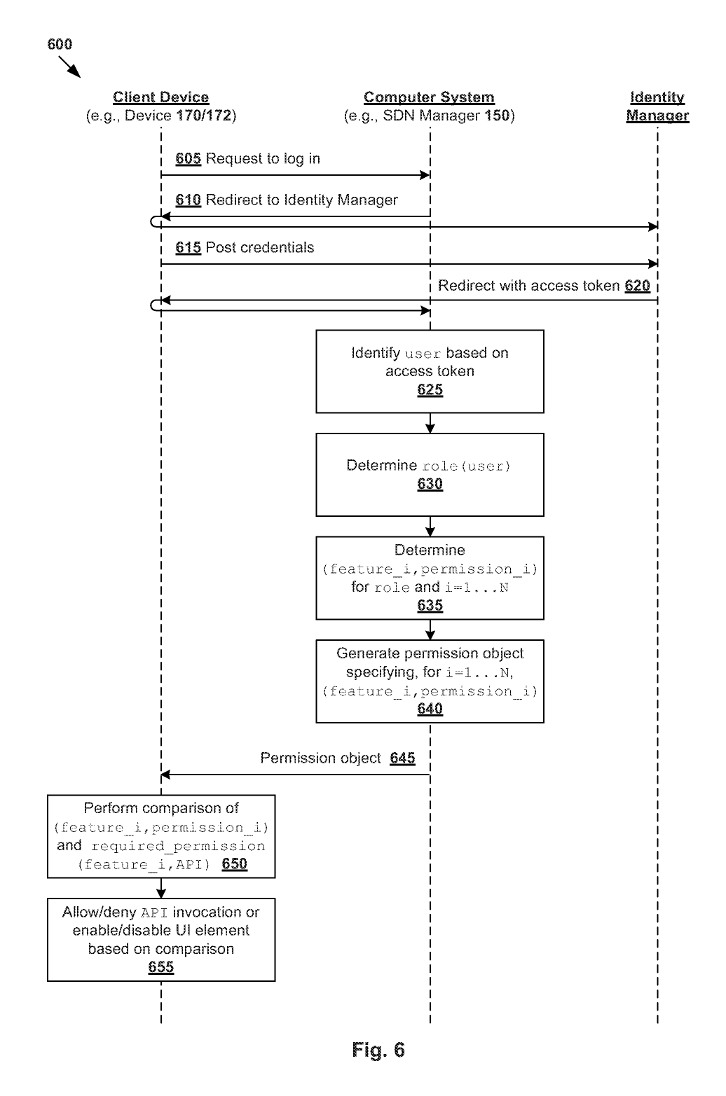

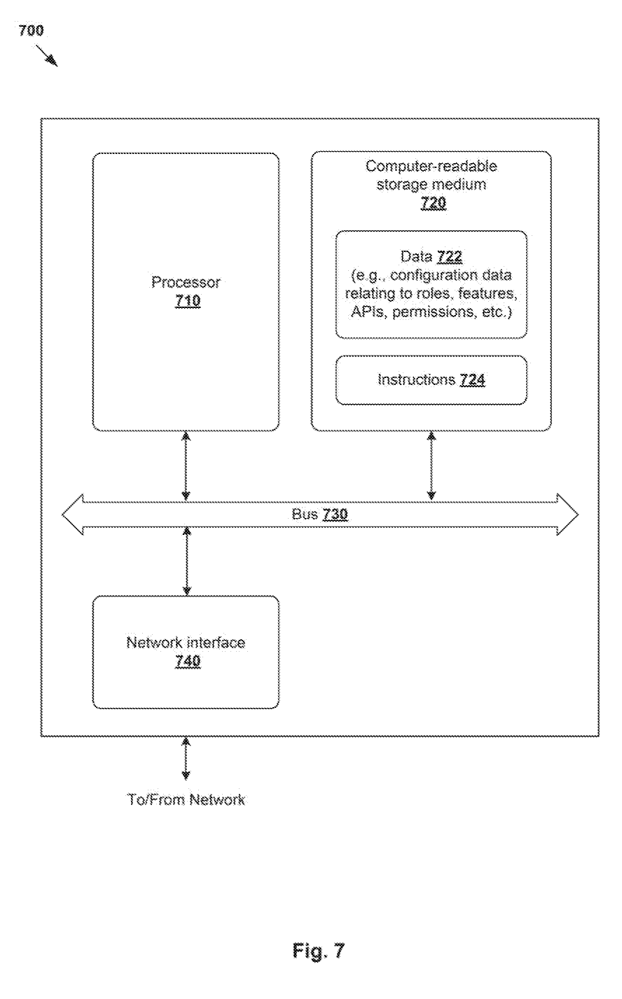

In the following, various examples will be discussed using FIG. 3 to FIG. 7. A first example relating to API invocation will be described using FIG. 3, FIG. 4, FIG. 5A and FIG. 5B. A second example relating to permission objects will be described using FIG. 6. An example computer system will be described using FIG. 7.

Detailed Process

FIG. 3 is a flowchart of example detailed process 300 for performing role-based access control with feature-level granularity in network environment 100. Example process 300 may include one or more operations, functions, or actions illustrated by one or more blocks, such as 305 to 375. The various blocks may be combined into fewer blocks, divided into additional blocks, and/or eliminated depending on the desired implementation. Blocks 305-320 are shown in dashed line to indicate that the configuration steps may be performed independently, or using a different computer system, compared to the subsequent 325-375. The example in FIG. 3 will be discussed using FIG. 4, which is a schematic diagram illustrating example configuration 400 of feature-level permissions according to the example in FIG. 3.

At 305 in FIG. 3, various custom roles are configured for users requiring access to web application 152. Each role may be configured by specifying any suitable attributes, such as name, description, etc. For example in virtualized computing environment 100, a user may be assigned with one or more of the following roles: enterprise administrator, auditor, network engineer, network operations, security engineer, security operations, tenant administrator, policy administrator, cloud administrator, etc.

At 310 in FIG. 3, a set of feature-level permissions is configured for each role. Using the example in FIG. 4, first feature=‘networking’ (see 410) and second feature=‘troubleshooting’ (see 420) both associate or assign role=‘enterprise administrator’ with feature-level permission=‘CRUD’ (see 412, 422). In other words, role=enterprise administrator has full access to both networking 410 and troubleshooting 420 features. In contrast, first feature=‘networking’ (see 410) associates role=‘network operations’ with feature-level permission=‘R’ (see 414), while second feature=‘troubleshooting’ (see 420) associates the same role with different feature-level permission=‘E’ (see 424). As such, role=‘network operations’ is granted with an execute permission to access troubleshooting feature 420, but only a read permission for networking 410.

At 315 in FIG. 3, a required permission is configured for an API associated with a particular feature of web application 152. The required permission represents the minimum permission a role should have in order to invoke the associated API. Different APIs may have different required permissions. Referring to FIG. 4 again, first feature=‘networking’ (see 410) is associated with a set of APIs that includes ‘connect( )’ with required permission=‘CRUD’ (see 416), ‘disconnect( )’ with ‘CRUD’ (see 418), and ‘download_table( )’ with ‘R’ (see 419), etc. In practice, ‘connect( )’ may be invoked to connect to a logical router, ‘disconnect( )’ to disconnect from the logical router and ‘download_table( )’ to download a routing table associated with the logical router.

Similarly, different permissions may be required to invoke different APIs associated with the second feature=troubleshooting (see 420). For example, ‘traceflow( )’ requires permission=‘CRUD’ (see 426) to inject of a packet at a virtual port associated with virtual machine 130/140 for identifying a path the packet traverses via various virtual entities (e.g., logical switches, logical routers, etc.). In contrast, ‘download_log( )’ only requires permission=‘R’ (see 428) to download log information.

At 320 in FIG. 3, one or more roles are assigned to a particular user, or a user group to which the user belong. For example in FIG. 4, first user=X is assigned with multiple roles=‘enterprise administrator’ and ‘network operations’ (see 430/450), while second user=Y is assigned with one role=‘network operations’ (see 440/460).

At 325 in FIG. 3, SDN manager 150 detects a request for user 180/182 operating client device 170/172 to access feature 410/420 supported by web application 152. For example, the request may be an API call request to invoke a particular API associated with feature 410/420, etc.

At 330 in FIG. 3, user authentication is performed. This may involve checking any suitable authentication credentials associated with user 180/182, such as username and password, etc. At 335, in response to determination that the authentication credentials are incorrect, SDN manager 150 sends a notification to client device 170/172 indicating that authentication has failed and the request at 325 is denied. Otherwise (authentication credentials are correct), the authentication is successful and SDN manager 150 proceeds to block 340.

At 340 to 375 in FIG. 3, access control is performed. In particular, at 340 and 345, SDN manager 150 identifies one or more roles assigned to the user, and a (highest) feature-level permission associated with the one or more roles. Next, at 350 and 355, a required permission associated an API invoked by the user is compared with the feature-level permission. At 360 and 365, in response to determination that the feature-level permission is greater than or equal to the required permission, the invocation of the API is allowed (i.e., request is allowed). Otherwise, at 370 and 375, access to the feature through the invocation of the associated API is denied. Some examples are shown in FIG. 4.

In a first example, user=X (see 430) sends a request to invoke API=‘connect( )’ (see 416). During access control, it is determined that the API is associated with first feature=‘networking’ (see 410) and user=X is assigned with multiple roles. Since first feature=‘networking’ associates first role=‘enterprise administrator’ with feature-level permission=‘CRUD’ (see 412) and second role=‘network operations’ with ‘R’ (see 414), it is determined that the user's (highest) feature-level permission=‘CRUD’ (i.e., ‘R’<‘CRUD’). Further, since the invocation of API=‘connect( )’ requires permission=‘CRUD’ (see 416), the API call is allowed (see 432). Similarly, the invocation of ‘disconnect( )’ and ‘download_table( )’ will be allowed (see 434 and 436).

In a second example, user=Y (see 440) also sends a request to invoke API=‘connect( )’ (see 416) associated with first feature=‘networking’ (see 410). The user is assigned with role=‘network operations.’ Since first feature=‘networking’ associates role=‘network operations’ with feature-level permission=‘R’ (see 414) that is less than the required permission=‘CRUD’ (see 416), the invocation of ‘connect( )’ is denied (see 442). For the same reason, the invocation of ‘disconnect( )’ will be denied (see 444). In contrast, the invocation of ‘download_table( )’ will be allowed because of its lower required permission=‘R’ (see 446).

In a third example, user=X (see 450) sends a request to invoke API=‘traceflow( )’ (see 426). Since second feature=‘troubleshooting’ (see 420) associates role=‘enterprise administrator’ with feature-level permission=‘CRUD’ (see 422) that satisfies the required permission=‘CRUD’ (see 426), the API invocation is allowed (see 452). For the same reason, user=X will be allowed to invoke API=‘download_log( ),’ which has a lower required permission=‘R’ (see 454).

In a fourth example, user=Y (see 460) sends a request to invoke API=‘download_log( )’ (see 428). Since second feature=‘troubleshooting’ (see 420) associates role=‘network operations’ with feature-level permission=‘E’ (see 424) that is greater than the required permission=‘R’ (see 428), the API invocation is allowed (see 464). In contrast, the same role does not allow the user to invoke API=‘traceflow( )’ with the required permission=‘CRUD’ (see 462), i.e., ‘E’<‘CRUD’.

From the above examples, it can be seen that feature-level permissions may be (indirectly) assigned to a role through respective features of web application 152. In practice, the configuration according to blocks 305-320 may be performed based on configuration information from any suitable user(s), such as a developer of web application 152, enterprise administrator, etc. SDN manager 150 may receive the configuration information via any suitable interface, such as graphical UI, CLI, API, etc. The configuration information may be stored in any suitable format, such as eXtensible Markup Language (XML), etc. For example, a feature-level permission may be defined as follows: <feature name=“networking”><role name=“enterprise administrator”><permission>CRUD</permission></role></feature>.

Some additional examples are shown in FIG. 5A, which is a schematic diagram illustrating example configuration information associated with feature-level permissions. Each role is associated with a set of feature-level permissions. For example, role=‘enterprise administrator’ (see 510) is associated with set=(CRUD, CRUD, CRUD, CRUD) for respective networking 520, troubleshooting 522, monitoring 524 and security configuration 526 features. Role=‘network operations’ (see 512) is associated with set=(R, E, E, R); role=‘network operations’ (see 514) with (CRUD, CRUD, CRUD, R); role=‘security engineer’ (see 516) with (None, E, E, CRUD); role=‘security operations’ (see 518) with (None, E, E, R); and role=‘auditor’ (see 519) with (R, R, R, R). This way, where necessary, the same role may have different permissions for different features.

FIG. 5B is a schematic diagram illustrating example configuration information associated with required permissions. For example, in relation to feature=‘monitoring,’ API=‘monitor_object1( )’ requires permission=‘E’ (see 530), while ‘monitor_object2( )’ requires permission=‘R’ (see 540). For feature=‘security configuration,’ API=‘manage_keys( )’ requires permission=‘CRUD’ (see 550). The required permission associated with networking and troubleshooting features have been explained using FIG. 4 and will not be repeated here. The configuration information in FIG. 5A and/or FIG. 5B may be read at startup of web application 152 and cached.

To facilitate role assignment in practice, multiple roles may be selected via an interface provided by SDN manager 150 to compare their respective feature-level permission sets. For example, first set=(CRUD, CRUD, CRUD, CRUD) associated with first role=‘network administrator’ (see 510) may be compared against second set=(CRUD, CRUD, CRUD, R) associated with second role=‘network engineer’ (see 514). For each feature, a set of APIs invocable by each role may also be presented for comparison purposes. New custom roles that have a desired set of feature-level permissions may also be created.

Permission Object

In the example implementation in FIG. 3, access control may be performed by SDN manager 150 in response to receiving a user's request to invoke an API. As will be described using FIG. 6 below, access control may be performed by generating a permission object and sending the permission object to client device 170/172. Here, the term “permission object” may refer generally to a data object specifying a set of feature-level permissions associated with one or more roles assigned to user 180/182.

In more detail, FIG. 6 is a flowchart of example detailed process 600 for performing role-based access control with feature-level granularity using a permission object. Example process 600 may include one or more operations, functions, or actions illustrated by one or more blocks, such as 605 to 655. The various blocks may be combined into fewer blocks, divided into additional blocks, and/or eliminated depending on the desired implementation. Although not shown in FIG. 6, the configuration according to blocks 305-320 in FIG. 3 may be performed before block 605.

At 605 and 610 in FIG. 6, in response to receiving a login request from user 180/182 operating client device 170/172, SDN manager 150 redirects the request to an identity manager. In this case, through Identity as a Service (IDaaS) technology, any operations relating to authentication may be delegated from SDN manager 150 to the identify manager, such as VMware Identity Manager™ (vIDM) available from VMware, Inc., etc. At 615 and 620, in response to a successful authentication based on the credentials (e.g., user name, password, etc.) provided by the user, the identity manager redirects client device 170/172 back to SDN manager 150 with an access token identifying the user.

At 625 in FIG. 6, SDN manager 150 detects a request for user 180/182 to access one or more features of web application 152 and identifies user 180/182 based on the access token. At 630, SDN manager 150 identifies role(s) associated with user 180/182 or a user group to which user 180/182 belongs. At 635, SDN manager 150 determines a set of feature-level permissions (feature_i, permission_i) associated with the role. As described using FIG. 4, each feature_i associates the role with a feature-level permission_i, where i=1, . . . , N and N is the total number of features supported by web application 152.

At 640 and 645, a permission object specifying the set of feature-level permissions is generated and sent to client device 170/172. In practice, the permission object may also be fetched by client device 170/172 using a pull approach, such as via an API call that specifies the corresponding user's role.

At 650 and 655, the permission object generated and sent by SDN manager 150 causes client device 170/172 to perform access control based on the set of feature-level permissions. For example, an invocation of an API through a UI or CLI may be allowed or denied, or a UI element associated with the API may be enabled or disabled on the UI. Examples of UI elements include windows, buttons, menus, text boxes, lists, application icons, menu bars, scroll bars, title bars, status bars, size grips, toolbars, dropdown lists, etc. A UI element that is disabled may be hidden or grey-out on a graphical UI. Some examples will be described below using FIG. 5A and FIG. 5B.

In a first example, user=Z1 is assigned with role=‘security engineer’ (see 516 in FIG. 5A). Based on the user's role, SDN manager 150 generates a permission object specifying a set of (feature_i, permission_i), i.e., (networking, none), (troubleshooting, E), (monitoring, E) and (security configuration, CRUD). Based on (networking, none), UI elements associated with APIs=‘connect( ),’ ‘disconnect( )’ and ‘download_table( )’ may be disabled (see 560, 570, 580 in FIG. 5B) on client device 170/172. Based on (troubleshooting, E), the invocation API=‘traceflow( )’ with required permission=‘CRUD’ will be denied (see 590 in FIG. 5B) by client device 170/172. Based on (monitoring, E), access to all associated APIs with required permission≤‘E’ will be allowed (see 530 and 540 in FIG. 5B). Further, based on (security configuration, CRUD), the invocation of API=‘manage_keys( )’ with required permission=‘CRUD’ will be allowed (see 550 in FIG. 5B).

In a second example, user=Z2 is associated with role=‘auditor.’ Based on the user's role (see 519 in FIG. 5A), SDN manager 150 generates a permission object specifying a set of a set of (feature_i, permission_i), i.e., (networking, R), (troubleshooting, R), (monitoring, R) and (security configuration, R). Based on the permission object, the invocation of the following first set of APIs with required permission >‘R’ will be denied: ‘connect( )’, ‘disconnect( ),’ ‘traceflow( ),’ ‘monitor_object1( ) and ‘manage_keys( ).’ In contrast, the invocation of the following second set of APIs with required permission=‘R’ will be allowed: ‘download_table( ),’ ‘download_log( )’ and ‘monitor_object2( ).’ Alternatively, UI elements associated with the first set may be disabled, and that associated with the second set enabled.

Computer System

The above examples can be implemented by hardware (including hardware logic circuitry), software or firmware or a combination thereof. FIG. 7 is a schematic diagram illustrating example computer system 700 to perform role-based access control with feature-level granularity in network environment 100. Example computer system 700 may include processor 710, computer-readable storage medium 720, network interface 740, and bus 730 that facilitates communication among these illustrated components and other components.

Processor 710 is to perform processes described herein with reference to the drawings. Computer-readable storage medium 720 may store any suitable data 722, such as configuration information relating to roles, features, feature-level permissions, APIs and corresponding required permissions, etc. Computer-readable storage medium 720 may further store computer-readable instructions 724 (“program code”) that, in response to execution by processor 710, cause processor 710 to perform processes described herein with reference to FIG. 1 to FIG. 6.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

What is claimed is:

1. A method for a computer system to perform role-based access control with feature-level granularity in a network environment that includes the computer system and a client device, wherein the method comprises:
detecting a request for a user operating the client device to access one or more features of a web application;
identifying a role assigned to the user;
identifying one or more feature-level permissions associated with the role, wherein a first feature of the web application associates the role with a first feature-level permission, and a second feature of the web application associates the role with a different second feature-level permission; and
controlling access to the one or more features based on the one or more feature-level permissions by allowing or denying access to the first feature based on the first feature-level permission, or to the second feature based on the second feature-level permission, or both.

2. The method of claim 1, wherein controlling access comprises:
allowing or denying an invocation of a first application programming interface (API) associated with the first feature based on the first feature-level permission.

3. The method of claim 2, wherein the method further comprises:
determining that the first API is associated with a first required permission, wherein the first feature is associated with a set of APIs that includes the first API, and a second API associated with a different second required permission; and
comparing the first required permission with the first feature-level permission to allow or deny the invocation of the first API.

4. The method of claim 3, wherein controlling access comprises:
in response to determination that the first feature-level permission is greater than or equal to required permission according to a permission hierarchy, allowing the invocation of the first API, but otherwise, denying the invocation of the first API.

5. The method of claim 1, wherein identifying the one or more feature-level permissions comprises:
identifying a set of feature-level permissions that includes the first feature-level permission and the second feature-level permission; and
generating a permission object specifying the set of feature-level permissions.

6. The method of claim 5, wherein controlling access comprises:
sending, to the client device, the permission object to cause the client device to, based on the first feature-level permission, allow or deny an invocation of a first API associated with the first feature through an interface of the web application, or to enable or disable a user interface (UI) element associated with the first API on the interface.

7. The method of claim 6, wherein controlling access comprises:
sending, to the client device, the permission object to cause the client device to compare a required permission associated with the first API and the first feature-level permission.

8. A non-transitory computer-readable storage medium that includes a set of instructions which, in response to execution by a processor of a computer system, cause the computer system to perform a method of role-based access control with feature-level granularity in a network environment that includes the computer system and a client device, and the method comprises:
detecting a request for a user operating the client device to access one or more features of a web application;
identifying a role assigned to the user;
identifying one or more feature-level permissions associated with the role, wherein a first feature of the web application associates the role with a first feature-level permission, and a second feature of the web application associates the role with a second feature-level permission, the first feature-level permission being different from the second feature-level permission; and
controlling access to the one or more features based on the one or more feature-level permissions by allowing or denying access to the first feature based on the first feature-level permission, or to the second feature based on the second feature-level permission, or both.

9. The non-transitory computer-readable storage medium of claim 8, wherein controlling access comprises:
allowing or denying an invocation of a first application programming interface (API) associated with the first feature based on the first feature-level permission.

10. The non-transitory computer-readable storage medium of claim 9, wherein the method further comprises:
determining that the first API is associated with a first required permission, wherein the first feature is associated with a set of APIs that includes the first API, and a second API associated with a second required permission that is different from the first required permission; and
comparing the first required permission with the first feature-level permission to allow or deny the invocation of the first API.

11. The non-transitory computer-readable storage medium of claim 10, wherein controlling access comprises:
in response to determination that the first feature-level permission is greater than or equal to required permission according to a permission hierarchy, allowing the invocation of the first API, but otherwise, denying the invocation of the first API.

12. The non-transitory computer-readable storage medium of claim 8, wherein identifying the one or more feature-level permissions comprises:
identifying a set of feature-level permissions that includes the first feature-level permission and the second feature-level permission; and
generating a permission object specifying the set of feature-level permissions.

13. The non-transitory computer-readable storage medium of claim 12, wherein controlling access comprises:
sending, to the client device, the permission object to cause the client device to, based on the first feature-level permission, allow or deny an invocation of a first API associated with the first feature through an interface of the web application, or to enable or disable a user interface (UI) element associated with the first API on the interface.

14. The non-transitory computer-readable storage medium of claim 12, wherein controlling access comprises:
sending, to the client device, the permission object to cause the client device to compare a required permission associated with the first API and the first feature-level permission.

15. A computer system, comprising:
a processor; and
a non-transitory computer-readable medium having stored thereon instructions that, when executed by the processor, cause the processor to perform the following:
detect a request for a user operating a client device to access one or more features of a web application;
identify a role assigned to the user;
identify one or more feature-level permissions associated with the role, wherein a first feature of the web application associates the role with a first feature-level permission, and a second feature of the web application associates the role with a different second feature-level permission; and
control access to the one or more features based on the one or more feature-level permissions by allowing or denying access to the first feature based on the first feature-level permission, or to the second feature based on the second feature-level permission, or both.

16. The computer system of claim 15, wherein the instructions for controlling access cause the processor to:
allow or deny an invocation of a first application programming interface (API) associated with the first feature based on the first feature-level permission.

17. The computer system of claim 16, wherein the instructions further cause the processor to:
determine that the first API is associated with a first required permission, wherein the first feature is associated with a set of APIs that includes the first API, and a second API associated with a different second required permission; and
compare the first required permission with the first feature-level permission to allow or deny the invocation of the first API.

18. The computer system of claim 17, wherein the instructions for controlling access cause the processor to:
in response to determination that the first feature-level permission is greater than or equal to required permission according to a permission hierarchy, allow the invocation of the first API, but otherwise, deny the invocation of the first API.

19. The computer system of claim 15, wherein the instructions for identifying the one or more feature-level permissions cause the processor to:
identify a set of feature-level permissions that includes the first feature-level permission and the second feature-level permission; and
generate a permission object specifying the set of feature-level permissions.

20. The computer system of claim 19, wherein the instructions for controlling access cause the processor to:
send, to the client device, the permission object to cause the client device to, based on the first feature-level permission, allow or deny an invocation of a first API associated with the first feature through an interface of the web application, or to enable or disable a user interface (UI) element associated with the first API on the interface.

21. The computer system of claim 19, wherein the instructions for controlling access cause the processor to:
send, to the client device, the permission object to cause the client device to compare a required permission associated with the first API and the first feature-level permission.
